(19) United States
(12) Patent Application Publication
(10) Pub. No.: US 2014/0258022 A1
(43) Pub. Date: Sep. 11, 2014

(54) Inferred Budget

(71) Applicants: Kamal Zamer, Austin, TX (US); James Brett Sowder, Austin, TX (US); Frank Anthony Nuzzi, Pflugerville, TX (US); Jayasree Mekala, Austin, TX (US)

(72) Inventors: Kamal Zamer, Austin, TX (US); James Brett Sowder, Austin, TX (US); Frank Anthony Nuzzi, Pflugerville, TX (US); Jayasree Mekala, Austin, TX (US)

(21) Appl. No.: 13/790,523

(22) Filed: Mar. 8, 2013

(51) Int. Cl. G06Q 30/06

(52) U.S. Cl. CPC G06Q 30/0631
USPC 705/26.7

(57) ABSTRACT

Methods and systems are provided for providing purchase recommendations and a budget to a user. The purchase recommendations can be for discretionary products for the user or for gifts for others. The purchase recommendations and the budget can be based upon the amount of discretionary money available for the user to make such purchases and for whom the purchases are to be made. The purchase recommendations and the budget can be further based upon purchase histories, wish lists, and calendars.

### BACKGROUND

1. Technical Field

The present disclosure generally relates to electronic commerce and, more particularly, relates to methods and systems for inferring a budget for recommended purchases.

2. Related Art

The use of e-commerce websites to purchase products online is well known. On e-commerce websites, people often purchase products for themselves, as well as for others. Thus, a person can purchase products to satisfy their everyday needs, indulge their hobbies and interests, or meet any other needs or desires. The person can purchase products to give as gifts for others.

Often, e-commerce websites create and maintain a purchase history for each customer. The purchase history typically lists what products were purchased by the customer, when the products were purchased, and how much was paid for each product. Other information, such as shipping method, delivery date, payment method, discounts provided, and the like can also be provided in the purchase history.

Often, e-commerce websites provide wish lists for their customers. Each customer can add products to such wish lists for later review and possible purchase. For example, a customer can add a product to a wish list because the product is not available at the time, because the customer cannot presently afford the product, because the customer is waiting for the product to go on sale, or simply because the customer has not yet made up her mind regarding the purchase.

### BRIEF DESCRIPTION OF THE DRAWINGS

FIG. 1 is a block diagram of a system for making product recommendations and inferring budgets, according to an embodiment;

FIG. 2 is a flow chart showing a method for making product recommendations and inferring budgets, according to an embodiment;

FIG. 3 is a flow chart showing further detail of the method for making product recommendations and inferring budgets, according to an embodiment; and

FIG. 4 is a block diagram of an example of a computer that is suitable for use in the system for making product recommendations and inferring budgets, according to an embodiment.

### DETAILED DESCRIPTION

It is not unusual for a user to have disposable income, e.g. discretionary money, that the user can use in any desired manner. The user can be unsure regarding how the disposable income should be spent. The user may not be fully aware of upcoming potential expenditures that need to be made or that should be made. For example, although the user may be somewhat aware that both Valentine's Day and the user's sister's birthday is approaching, the user may not have yet given either much thought. In particular, the user may not have decided what gifts to purchase for the user's spouse and for the user's sister. Further, the user may have been considering several discretionary purchases to indulge the user's hobbies and interests. The user may not know how much money is available for such purchases, what products to purchase, or when the products should be purchased. Therefore, it would be beneficial to provide a method and system for assisting the user with one or more purchase recommendations, an inferred budget, and a schedule for making such purchases.

According to an embodiment, an amount of discretionary money (e.g., money available for purchasing non-essential products such as hobby products and gifts) can be determined. The discretionary money can be in one or more accounts. For example, a portion of the discretionary money can be in the user's checking account, a portion of the discretionary money can be in the user's payment provider account, and/or a portion of the discretionary money can be in the user's savings account. The amount of discretionary money can be determined by subtracting an amount of money needed to pay bills and make required purchases, such as from the account totals. The amount of discretionary money can be projected for the future using known or estimated income and expenses.

The amount of discretionary money can be communicated to the user and can be confirmed by the user. The user can be given an opportunity to modify the amount of discretionary money, such as by setting some aside for other purchases, such as for non-discretionary purchases that were not considered by the inferred budget system. The amount of discretionary money can be modified by changing income and/or expense amounts assumed or used by the inferred budget system.

The user can predetermine or set aside an amount of money in the user's account(s) that is not be used in determining the amount of discretionary money. Thus, the user can establish a contingency fund that is not to be used in determining the amount of discretionary money. The contingency fund can be split among two or more accounts. Thus, a portion of the contingency fund can be in user's checking account, a portion of the contingency fund can be in the user's payment provider account, and/or a portion of the contingency fund can be in the user's savings account. The amount of the contingency fund in each account can be predetermined, such as in a setup procedure for the inferred budget system that is performed using an app. The amount of the contingency fund in each account can be determined and/or modified substantially in real time, such as via the app. The amount of the contingency fund in each account can grow at a predetermined rate.

According to an embodiment, at least some of the discretionary money can be budgeted for discretionary purchases. The discretionary purchases can be for the user and/or for others. For example, the discretionary purchases can be for indulging the hobbies and interest of the user. As a further example, the discretionary purchases can be gifts for people other than the user. The gifts can be for birthdays, Christmas, Valentine's day, Mother's Day, Father's day, or any other day or purpose. The discretionary purchases can be for any discretionary purpose.

According to an embodiment, the inferred budget system can project discretionary money. Thus, all or a portion of the amount of discretionary money can be money that is not available at a given instant. Rather, all or a portion of the amount of discretionary money can be money that is expected to be available in the future. Such money can be available in the future from sources such as the user's paycheck, retirement income, rental income, Social Security, an annuity, or any other periodic or regular source of income. Such money can be available in the future from irregular or exceptional sources of income, as payment for doing odd jobs, as gifts, as inheritances, and the like. The amounts and expected dates for irregular sources of income can be communicated to the inferred budget system by the user via the app, for example.

According to an embodiment, the inferred budget system can use information regarding the intended recipient of a product for providing a recommendation regarding the product. The inferred budget system can use the identity of the intended recipient to determine what product to recommend, when the product is to be purchased, and how money is to be spent on the product. Such information, for either the user or for the intended recipient, can be obtained from an e-commerce website, a payment provider website, a credit card website, a bank website, a social network website, or any other website or source.

Information regarding what products to purchase for the user can be obtained from websites related to other people (such as from their social networking websites, merchant websites, and payment provider websites). Similarly, information regarding what products, e.g., gifts, to purchase for other people can be obtained from the user's websites (such as from the user's social networking websites, merchant websites, and payment provider websites). Thus, information that can be helpful in determining what products to recommend for a given person can be obtained from that person's websites, as well as from other people's websites.

According to an embodiment, the inferred budget system can use calendar information for providing a recommendation regarding the product. The inferred budget system can use a personal calendar for providing a recommendation regarding the product. The inferred budget system can use a calendar of the user for providing a recommendation regarding the product. The inferred budget system can use a calendar of the intended recipient for providing a recommendation regarding the product. The inferred budget system can use any other calendar, such as a general purpose calendar or a calendar of any other person, for providing a recommendation regarding the product. For example, the inferred budget system can use a calendar of the user to determine when friends, relatives, and business acquaintances of the user have birthdays and this calendar information can be used for providing a recommendation regarding gift purchases for such people. As a further example, the inferred budget system can use a general purpose calendar to determine when holidays such as Christmas, Valentine's day, Mother's day, and Father's day are approaching and this calendar information can be used for providing gift recommendations for such people.

A general purpose calendar can be used to determine other information that can be used, at least in part, to provide a recommendation regarding the product. For example, the general purpose calendar can be used to determine what season it will be when the gift is given. The product recommendation can then be for a gift that is appropriate for the season. Thus, for example, a scarf can be given in the autumn or winter, rather than in the middle of a hot summer.

According to an embodiment, one or more purchase histories can be used for providing a recommendation regarding the product. The inferred budget system can use a purchase history of the user for providing a recommendation regarding the product. The purchase history of the user can be used for providing a recommendation for a product for the user or for providing a recommendation for a product for another person, e.g., an intended gift recipient. The inferred budget system can use a purchase history of the intended gift recipient for providing a recommendation regarding the product. The purchase history of the intended gift recipient can be used for providing a recommendation for a product for the user or for providing a recommendation for a product for another person, e.g., the intended gift recipient.

According to an embodiment, one or more wish lists can be used for providing a recommendation regarding the product. The inferred budget system can use a wish list of the user for providing a recommendation regarding the product. The wish list of the user can be used for providing a recommendation for a product for the user or for providing a recommendation for a product for another person, e.g., an intended gift recipient. The inferred budget system can use a wish list of the intended recipient for providing a recommendation regarding the product. The wish list of the intended gift recipient can be used for providing a recommendation for a product for the user or for providing a recommendation for a product for another person, e.g., the intended gift recipient.

Purchase histories, wish lists, and the like can be used, at least in part, to infer product recommendations and budgets for a user. Social networks can be used, at least in part, to infer product recommendations and budgets for a user. For example, liked products on social network websites can be used, at least in part, to infer product recommendations and budgets for a user. In this manner, the user can better and more easily determine what product to purchase with discretionary money. Such recommendations and budgets can make shopping substantially easier for the user. Indeed, shopping can be, at least to some degree, automated.

Shopping can be substantially, e.g., fully, automated. The inferred budget system can purchase the recommended products, arrange for delivery of the recommended products, pay for the recommended products, and verify receipt of the recommended products, all without user intervention.

User defined messages or system defined messages can accompany delivered products, such as when the products are gifts. The system can define occasion specific messages. For example, when flowers are sent from a man name John on Valentine's Day, the system can automatically include the message, “Happy Valentine's Day from John.” Such automated purchasing and/or messages can be set up in a setup process or at any other time.

The system can define messages using information from merchant's websites, payment provider websites, social network websites and the like. Such information can include personal information regarding the intended gift recipient and/or friends of the intended gift recipient. For example, a message can state “I hope that you and your friend James enjoy the two basketball game tickets,” by using information regarding the intended gift recipient's friends names and interests that was obtained from one or more social network websites.

The user can provide gift recipient specific messages, as well as holiday or birthday specific messages. The use can set up any number of messages in advance for use with specific gift recipients on specific occasions. Thus, the user can predetermine any number of specific messages for specific people, to be used on specific dates in the future. The system can add to or augment such messages based, at least in part, upon the person, date, news, or any other information.

The system can create and maintain a database of the user's relatives, friends, business acquaintances, and the like. The database can include information regarding their birthdays, their kid's birthdays, their anniversaries, and other important dates for these people. The database can include information regarding the hobbies, interests, and likes of these people. The database can include information regarding the past gifts given to these people and regarding past purchase made by these people. The database can be used, alone or in cooperation with other information as discussed herein, to provide gift recommendations for these people.

Purchases made using the inferred budget system can be for any purpose. For example, such purchases can be for personal use or can be for gifts. Purchases made using the inferred budget system can be for any person, business, or other entity. Purchases made using the inferred budget system can be from brick and mortar stores. Purchases made using the inferred budget system can be from online stores.

Purchase recommendations can be for gifts that relate to items owned by the intended gift recipients. For example, the user may have previously given a bicycle to a child. An appropriate gift recommendation for the child may be for a helmet, horn, or bell for use with the bicycle. As another example, a website may indicate that a new business acquaintance of the user owns a classic car. An appropriate gift recommendation for the business acquaintance may be a car cover or detailing gift certificate.

The inferred budget system can be configured to take advantage of manufacturer, distributer, merchant, and/or other incentives. The inferred budget system can be configured to shop around for recommended products in an attempt to find the best deal for such products. Recommendations to the user can specify various incentives so that the user can select which products to purchase. Recommendations to the user can be based, at least in part, upon incentives so that the user can benefit therefrom.

Shipping costs, taxes, and any other costs can be considered by the inferred budget system when selecting among alternative products or when selecting among the same product from alternative sources. Similarly, delivery date can be considered by the inferred budget system when selecting amount alternative products or when selecting among the same product from alternative sources. Thus, costs can be mitigated and deliver time can be enhanced by the inferred budget system.

According to an embodiment, the inferred budget system can use any purchase history or wish list, such as a purchase history and/or wish list of a relative or friend, for providing the recommendation regarding the product. For example, when an inadequate purchase history or wish list is available for a particular intended recipient, then a purchase history or wish of a friend or relative of the intended recipient can function as a proxy for a purchase history of the intended recipient. That is, the inferred budget system can assume that the proxy would like products similar to those liked by the intended recipient. The user can specify who the proxy is, such as during the setup process or substantially in real time. The user can specify a proxy who the user believes has similar interest and needs with respect to the intended recipient. The proxy can be anyone that the user specifies.

The proxy can be selected by the system. The system can use information available from online sources, such as social network websites, in an attempt to identify a proxy who has similar interests with respect to an intended gift recipient. The proxy can be a friend of the intended gift recipient or can be unknown to the intended gift recipient. The proxy can be a person whose profile is at least somewhat similar to that of the gift recipient. The proxy can be a person whose demographics are at least somewhat similar to that of the gift recipient.

The purchase history and/or the wish list can be created by the inferred budget system for the user and/or intended gift recipients of the user. The purchase history and/or wish list can be created using purchase histories and/or wish lists of others. For example, the purchase history and/or wish list can be created using purchase histories and/or wish lists of other people who have similar demographics with respect to the user and/or intended gift recipients of the user. The purchase history and/or wish list can be created using any available information. For example, the purchase history and/or wish list can be created using any information available for the user and/or intended gift recipients of the user, using addition information from one or more other people with similar demographics, using information from friends and/or relatives of the user, and using any other available information.

The purchase history and/or the wish list can be augmented or modified by the inferred budget system for the user and/or intended gift recipients of the user. The purchase history and/or wish list can be augmented or modified using purchase histories and/or wish lists of others, as described above. The purchase history and/or the wish list can be created, augmented, or modified in any desired manner.

According to an embodiment, the inferred budget system can provide purchase recommendations and a budget to the user. The purchase recommendation can be for discretionary products for the user and/or for gifts for others. The purchase recommendations and the budget can be based, at least in part, upon the amount of discretionary money available for the user to make such purchases and can be based, at least in part, on the person for whom the purchases are to be made. The purchase recommendations and the budget can be further based, at least in part, upon purchase histories, wish lists, and calendars.

According to an embodiment, the inferred budget system can provide purchase recommendations and a budget in a desire order. The order can define a priority for making such purchases. For example, the inferred budget system can provide purchase recommendations and a budget listed according to relevancy, such as with the most relevant purchase recommendation listed first, or vice versa. Purchase recommendations can be considered more relevant if the purchase recommendations are considered to be made with more confidence.

A recommendation can be considered to be made with more confidence if it more closely matches a product from the user's or recipient's purchase history or wish list. For example, if the user has a history of purchasing many accessories associated with skiing and few accessories associated with surfing, then skiing accessories can be assigned higher relevance with respect to surfing products.

The user can be presented with all of the relevant product recommendations and/or the budgets associated therewith. The user can be presented with any desired number of the relevant product recommendations and/or the budgets associated therewith. For example, the user can be present with one, two, three, four, five, or more product recommendations and/or the budgets associated therewith. The user can specify how many relevant product recommendations are to be listed, such as during the setup process or substantially in real-time.

The order in which products are listed can be according to date on which the purchase should be made (such as to assure on time delivery), the cost of the products, the availability of purchase incentives (such as when sales will end) or any other criteria. The user can specify how the order of purchase recommendations is listed, such as during the setup process or substantially in real-time.

The inferred budget system can be configured to determine gifts for others based, at least in part, upon the user's purchase history and/or wish list. For example, if the user has purchased a particular gift product prior to a typical gift giving date in the past, then this information can be used for gift recommendations in the future. As a more particular example, if the user has purchased flowers the day before Valentine's Day in the past, then the inferred budget system can assume that the flowers were a Valentine's Day gift and can recommend the purchase of flowers on the day before Valentine's Day in the future. The inferred budget system can provide a budget that includes such purchases.

The budget can be determined by considering factors such as expected income and expected expenses during the budget period. The budget can be determined by assuming that future income will be substantially the same as past income and that future expenses will be substantially the same as past expenses. Any exceptions regarding income and expenses can be provided by the user to facilitate the preparation of a more accurate budget.

For example, assume that Kamal is a regular user of an e-commerce site. He makes purchases for himself, as well as others. Based on the time of year, Kamal can be presented with recommendations which are consistent with his purchase history. A budget can be inferred to determine help determine what products are provided in the recommendation. The budget can be provided to Kamal with the recommendation.

For example, assume that it is almost Kamal's girlfriend's birthday. Last year Kamal spent $200 on gifts for her, so a budget of $200 can be inferred. The budget can be increased with time, e.g., from year to year, based, at least in part, upon factors such as inflation and Kamal's income. Using wish lists Kamal has created on various websites, as well as items that he has pinned on Pinterest, we know at least some of the products that Kamal is considering as gifts for his girlfriend. Assume that last year Kamal bought his girlfriend a gold necklace. Assume that Kamal has pinned some jewelry on Pinterest. Given these data points, we will infer that Kamal would be willing to buy a $200 piece of jewelry that matches what he has pinned or has explicitly “wished” for in a wish list. Products that match these criteria can be presented to Kamal. If the jewelry Kamal has pinned is only $150, then the remainder of the $50 inferred budget can be used to present complementary jewelry or other products Kamal is interested in buying. The inferred budget can attempt to use Kamal's entire inferred budget (maybe a little more or less) when recommending products.

Thus, discretionary money can remain after defining the inferred budget and/or after spending the amount of money of the inferred budget. That is, the inferred budget may not require or use all of the discretionary money. When an amount of discretionary money remains after defining the inferred budget, then the remaining discretionary money can be used for any desired or predefined purposed. For example, such amounts of discretionary money can be maintained for use in purchasing future products using a future inferred budget, can be used to purchase a gift for another person and/or occasion, can be moved to another account (such as a savings account), can be used to pay future bills, can be taken by the user as cash (such as via an automated teller machine or ATM) and/or can be used to pay off loans more quickly, as defined by the user, such as in a setup process.

The more information that is available regarding products that Kamal has purchased, the more inferences that can be made regarding which products Kamal might be interested in purchasing. If there is insufficient or no such data regarding Kamal's purchases, then his social network can be used to analyze his friends' purchases as well as what purchases Kamal has been discussing with his friends. For example, if Kamal is talking about new Air Jordans on Facebook, then he should be presented with men's athletic shoes, such that Nike shoes, Air Jordans, and the like.

According to an embodiment, the inferred budget system can comprise one or more memories that store purchase information. One or more hardware processors can be in communication with the one or more memories and can be operable to access the purchase information. The one or more hardware processors can determine, at least in part from the purchase information, a recommendation for purchasing a product and can determine, at least in part from the recommendation, a budget for purchasing the product. The one or more hardware processors can send to the user a communication including the recommendation and the budget.

The recommendation can be based, at least in part, upon an amount of discretionary money available in at least one account of the user. Thus, when a user has more discretionary money available, then more products and/or more expensive products can be recommended.

The one or more hardware processors can be operable to determine the amount of discretionary money. The one or more hardware processors can determine the amount of discretionary money by querying one or more accounts of the user. The one or more hardware processors can sum money amounts in different accounts of the user to determine, at least in part, the amount of discretionary money. The one or more hardware processors can subtract from the sum any non-discretionary money. Non-discretionary money can be money that is needed to pay bills and purchase necessary products for the user.

The one or more hardware processors can be operable to determine the amount of discretionary money based, at least in part, upon the purchase information. The purchase information can provide an indication of what necessary products the user purchases. For example, such necessary products can include food, rent, gas, car insurance, and the like.

The purchase information can comprise a purchase history. For example, the purchase information can comprise a purchase history from an e-commerce website, a payment provider website, a social network website, or any other website.

The purchase information can comprise a wish list. For example, the purchase information can comprise a wish list from an e-commerce website, a payment provider website, a social network website, or any other website.

The recommendation can be based, at least in part, upon previous purchases of the user. Previous purchases of the user can provide an indication of the user's interests. For example, if the user has purchased tickets to Red Sox games in the past, it is likely that the user would like to attend a Red Sox game in the future.

The recommendation can be based, at least in part, upon previous purchases of the intended gift recipient. Previous purchases of the intended gift recipient can provide an indication of the intended gift recipient's interests. For example, if the intended gift recipient has purchased tickets to Red Sox games in the past, it is likely that the intended gift recipient would like to attend a Red Sox game in the future.

The one or more hardware processors can be operable to receive authorization from the user to purchase the product. Authorization for all or selected purchases can be pre-arranged, such as during the setup process. Authorization for purchases can be pre-arranged, such as during the setup process on a product category basis. Different categories of product can be defined and some categories can require realtime authorization while other categories can use pre-arranged authorization. For example, the purchase of toys can use pre-arranged authorization while the purchase of jewelry can require realtime authorization for each purchase.

Different categories of product cost can be defined and some categories can require realtime authorization while other categories can use pre-arranged authorization. For example, the purchase of products costing less than $25 can use pre-arranged authorization while the purchase of product costing $25 or more can require realtime authorization for each purchase.

The one or more hardware processors can be operable to receive a modification to the recommendation and budget from the user. Thus, the user can modify product recommendations and/or budgets on a case-by-case basis. The user can modify any setup information regarding product recommendations and/or budgets on a basis that affect all recommendations and/or budgets.

The one or more hardware processors can be operable to provide the recommendation in response to a request from user. Thus, the user can request product recommendations. The user can specify a budget for product recommendation. For example, the user can expect a bonus of $100 and can request product recommendation for a budget of $100, including any tax and shipping costs.

The one or more hardware processors can be operable to provide the recommendation automatically. The one or more hardware processors can provide recommendations in response to the availability of discretionary money. The one or more hardware processors can provide recommendations in response to events. For example, the one or more hardware processors can provide recommendations in response to approaching holidays and birthdays.

For example, the one or more hardware processors can be operable to recognize that an unusually large amount of money has been added to a user account. The one or more processors can verify that the money is discretionary money, such as by considering the user's upcoming expenses, by querying the user, or both. Any portion of the unusually large amount of money that is discretionary money can be used to make product recommendations and/or to infer budgets.

Sending the user the communication including the recommendation and the budget can comprise sending the communication to a user device. For example, sending the user the communication including the recommendation and the budget can comprise sending the communication to a smart phone of the user.

The one or more memories can be one or more memories of a server. The one or more hardware processors can be one or more hardware processors of a server. The one or more memories and the one or more hardware processors can be part of any device or system owned by any entity.

According to an embodiment, a method can comprise storing, such as in the one or more memories, purchase information. The method can comprise accessing, such as via one or more hardware processors in communication with the one or more memories, the purchase information. The method can comprise determining, via the one or more hardware processors and at least in part from the purchase information, a recommendation for purchasing a product and can comprise determining, via the one or more hardware processors and at least in part from the recommendation, a budget for purchasing the product. The method can comprise sending to the user a communication including the recommendation and the budget.

According to an embodiment, a computer program product can comprise a non-transitory computer readable medium having computer readable and executable code for instructing one or more processors to perform any of the methods disclosed herein. For example, the method can comprise storing purchase information, accessing the purchase information, determining a recommendation for purchasing a product, determining a budget for purchasing the product, and sending to the user a communication including the recommendation and the budget.

The one or more memories and one or more hardware processors can be part of the same device, e.g., server. The one or more memories and one or more hardware processors can be part of the different devices, e.g., servers. The one or more memories and one or more hardware processors can be co-located. The one or more memories and one or more hardware processors can be located in different places, e.g., different rooms, different buildings, different cities, or different states.

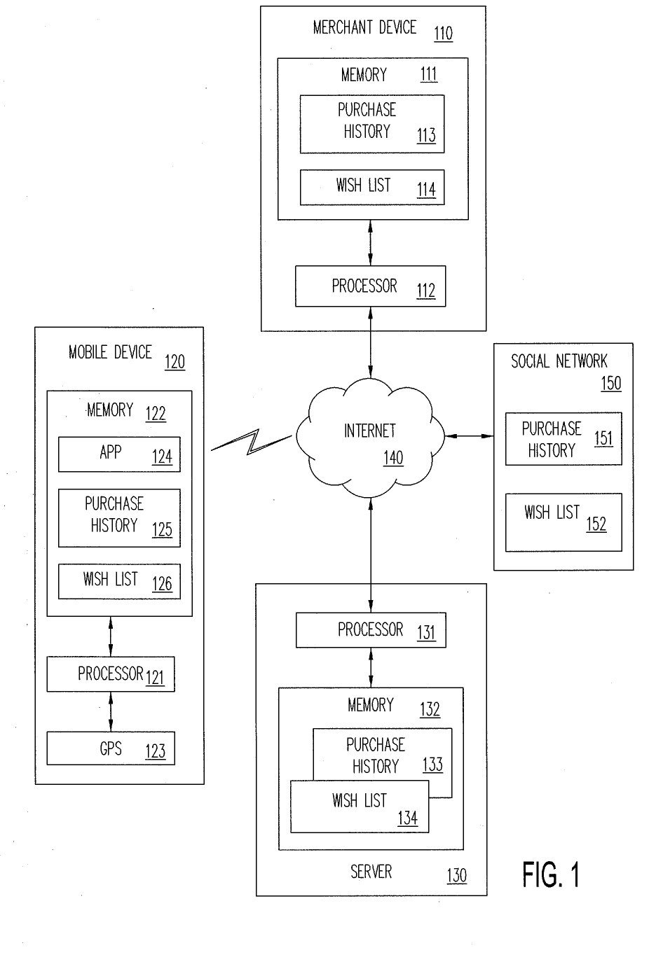

FIG. 1 is a block diagram of a system for making product recommendations and inferring budgets for purchasing such products, according to an embodiment. The system can include a merchant device 110, a mobile device 120, a payment server 130, and/or a social network 150. The functions discussed herein can be split and/or shared amount the merchant device 110, the mobile device 120, the payment server 130, and/or the social network 150, as desired.

The merchant device 110 can comprise a merchant checkout terminal, a computer, and/or a server, for example. The merchant device 110 can include a memory 111 and a processor 112. The memory 111 can store a purchase history 113 and/or a wish list 114. The purchase history 113 and/or the wish list 114 can be a purchase history 113 and/or a wish list 114 of the user. The purchase history 113 and/or the wish list 114 can be a purchase history 113 and/or a wish list 114 of the intended gift recipient. The merchant device 110 can be used for processing purchases from the merchant. The merchant device 110 can be used for—making product recommendations and inferring budgets, as disclosed herein. The merchant device 110 can be used for any other purposed.

The mobile device 120 can be carried by the user. The mobile device 120 can comprise a cellular telephone, a smart telephone, a hand held computer, a laptop computer, a notebook computer, or a tablet computer, for example. The mobile device 120 can include a processor 121, a memory 122, and a global positioning system (GPS) 123.

The mobile device 120 can be used for routine telephone calls, text messaging, web browsing, and the like. The mobile device 120 can be used for making product recommendations and inferring budgets, as disclosed herein. The mobile device 120 can be used for any other purposed.

An app 124 can be stored in the memory 122 and executed by the processor 121. The app 124 can be used for practicing the method and system for providing inferred budgets, as disclosed herein.

The memory 122 can store a purchase history 125 and/or a wish list 126. The purchase history 125 and/or the wish list 126 can be a purchase history 125 and/or a wish list 126 of the user. The purchase history 125 and/or the wish list 126 can be a purchase history 125 and/or a wish list 126 of the intended gift recipient.

The GPS 123 can be used, at least in part, for making product recommendations and/or inferring budgets. The product recommendations can depend, at least in part, upon where user or intended gift recipient is located. The location of the intended gift recipient can be obtained from a GPS of the intended gift recipient's mobile device. For example, if the user is vacationing at a ski resort, the product recommendation can be for a new pair of ski gloves that can be picked at a store near the ski resort.

The server 130 can comprise a server of a payment provider, such as Paypal, Inc. The server 130 can comprise a server of a credit card company, a bank, a social network, a merchant, or any other entity. The server 130 can be a server that is dedicated to recommending products and/or inferring budgets. The server 130 can be a single server or can be a plurality of servers. The server 130 can include one or more processors 131 and a memory 132. The memory 132 can be a memory of the server 130 or a memory that is associated with the server 130. The memory 132 can be a distributed memory.

The memory 132 can store a purchase history 133 and/or a wish list 134. The purchase history 133 and/or the wish list 134 can be a purchase history 133 and/or a wish list 134 of the user. The purchase history 133 and/or the wish list 134 can be a purchase history 133 and/or a wish list 134 of the intended gift recipient.

The server 130 can be used for making product recommendations and inferring budgets, as disclosed herein. The server 130 can be used for any other purposed.

The social network 150 can include a purchase history 151 and/or a wish list 152. The purchase history 151 and/or the wish list 152 can be a purchase history 151 and/or a wish list 152 of the user. The purchase history 151 and/or the wish list 152 can be a purchase history 151 and/or a wish list 152 of the intended gift recipient.

The social network 150 can be used for making product recommendations and inferring budgets, as disclosed herein. The social network 150 can be used for any other purposed.

Generally, the merchant device 110, the mobile device 120, the payment server 130, and the social network 150 can perform functions discussed herein. That is, at least to some extent, a function that is discussed herein as being performed via one of these devices can be performed by a different one of these devices or by a combination of these devices.

The merchant device 110, the mobile device 120, the payment server 130, and the social network 150 can communicate with one another via a network, such as the Internet 140. The merchant device 110, the mobile device 120, the other mobile devices 130, and the server 160 can communicate with one another via one or more networks, such as local area networks (LANs), wide area networks (WANs), cellular telephone networks, and the like. The merchant device 110, the mobile device 120, the other mobile devices 130, the social network 150, and the server 130 can communicate with one another, at least partially, via one or more near field communications (NFC) methods or other short range communications methods, such as infrared (IR), Bluetooth, WiFi, and WiMax.

FIG. 1 illustrates an exemplary embodiment of a network-based system for implementing one or more processes described herein. As shown, the network-based system may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or another suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

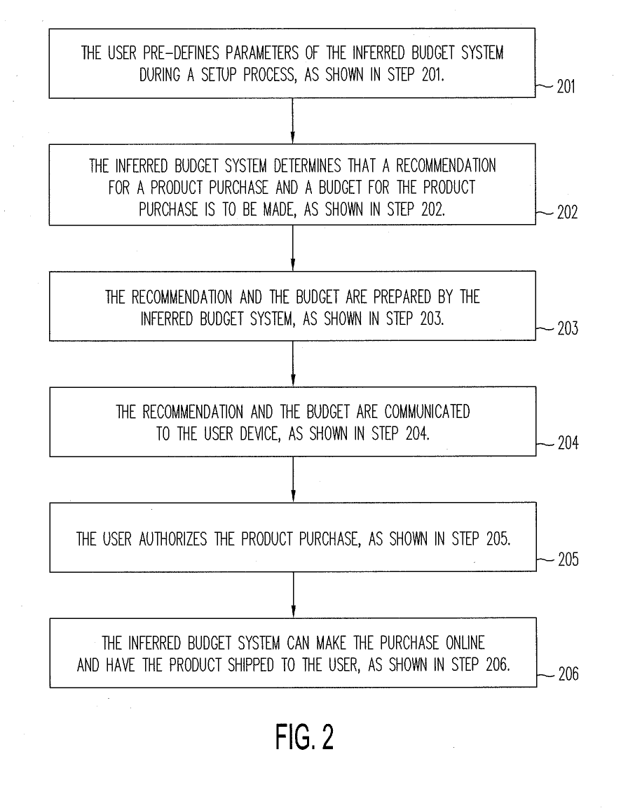

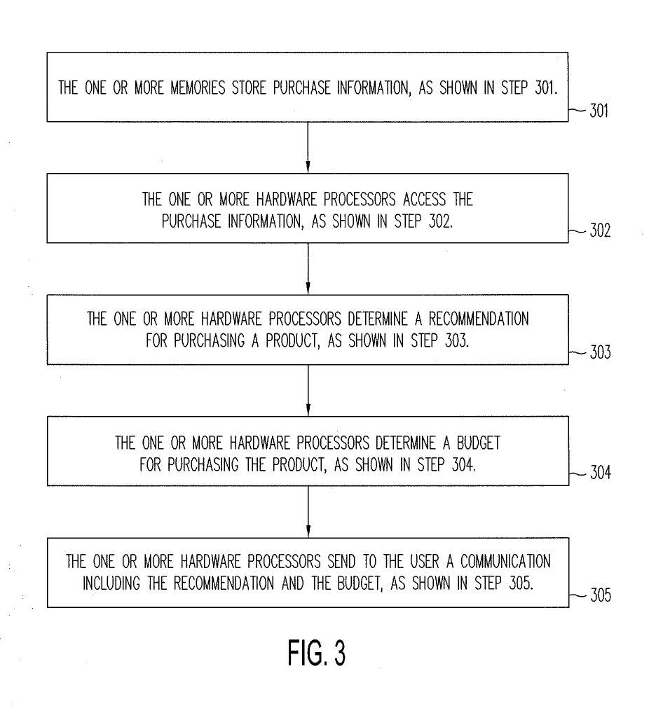

FIGS. 2 and 3 are flow charts that describe examples of operation of the method for providing inferred budgets, according to embodiments thereof. Note that one or more of the steps described herein may be combined, omitted, or performed in a different order, as desired or appropriate.

FIG. 2 is a flow chart showing a method for making product recommendations and inferring budgets, according to an embodiment. The user can pre-define parameters of the inferred budget system during a setup process, as shown in step 201. The user can modify the parameters at any other time, such as substantially in real-time.

The inferred budget system can determine that a recommendation for a product purchase and a budget for the product purchase are to be made, as shown in step 202. The inferred budget system can make this determination based upon the amount of discretionary money available to the user, the calendar, product availability, product purchase incentives, and/or any other desired criteria. For example, the inferred budget system can determine that a recommendation for a product purchase and a budget for the product purchase are to be made when the user has sufficient discretionary money to purchase a relevant product, such as a birthday gift.

The recommendation and the budget can be prepared by the inferred budget system, as shown in step 203. The budget can be a budget for purchasing the recommended product or products. The budget can take into consideration taxes, shipping costs, and any incentives.

The recommendation and the budget can be communicated to the user device 120, as shown in step 204. The recommendation and the budget can be communicated to the user device 120 via email, text messaging, or any other means. The recommendation and the budget can be communicated to the user device via the app 124. Thus, the app 124 can display the recommendation and the budget. The user can be notified by the app 124 that the app 124 has the recommendation and the budget ready for the user to view.

The user can authorize the product purchase, as shown in step 205. Alternatively, the inferred budget system can automatically purchase the product, as disclosed herein. The inferred budget system can make the purchase online and have the product shipped to the user, as shown in step 206.

FIG. 3 is a flow chart showing further detail of the method for making product recommendations and inferring budgeting, according to an embodiment. The one or more memories can store purchase information, as shown in step 301. The one or more hardware processors can access the purchase information, as shown in step 302. The one or more hardware processors can determine a recommendation for purchasing a product, as shown in step 303. The one or more hardware processors can determine a budget for purchasing the product, as shown in step 304. The one or more hardware processors can send to the user a communication including the recommendation and the budget, as shown in step 305.

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In one embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

Payment processing can be through known methods, such as transaction details being communicated to the payment provider through the app, the payment provider processing the details, which may include user account and identifier information and authentication, merchant information, and transaction details. The user account may be accessed to determine if any restrictions or limitations may prevent the transaction from being approved. If approved, the payment provider may send a notification to the merchant and/or the user.

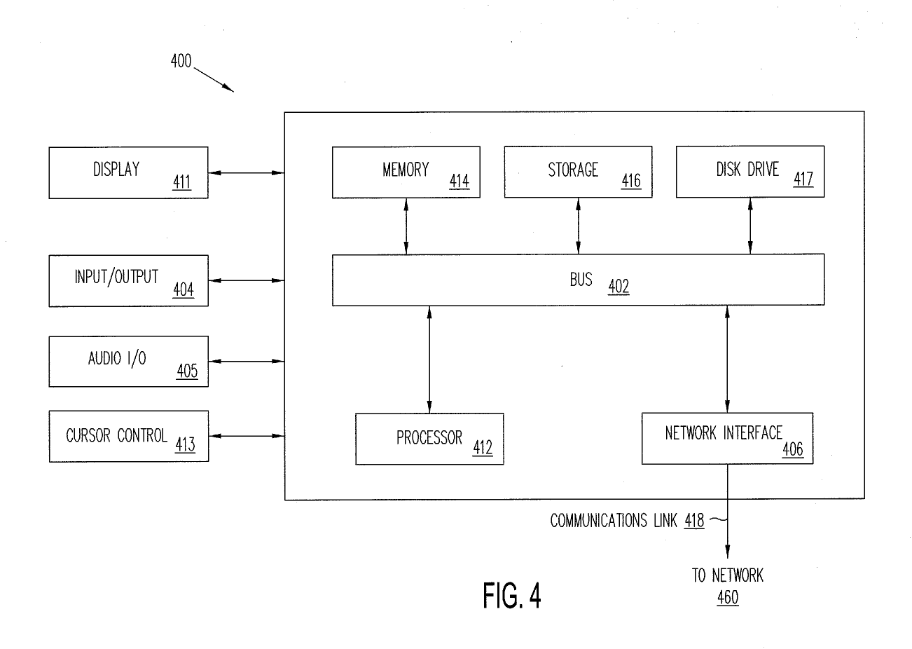

FIG. 4 is a block diagram of a computer system 400 suitable for implementing one or more embodiments of the present disclosure. In various implementations, the PIN pad and/or merchant terminal may comprise a computing device (e.g., a personal computer, laptop, smart phone, tablet, PDA, Bluetooth device, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as a user device, a merchant server, or a payment provider server via network 460. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, E2PROM, FLASH-EPROM, any other memory chip or cartridge, carrier wave, or any other medium from which a computer is adapted to read.

In various embodiments, execution of instruction sequences for practicing the invention may be performed by a computer system. In various other embodiments, a plurality of computer systems coupled by a communication link (e.g., LAN, WLAN, PTSN, or various other wired or wireless networks) may perform instruction sequences to practice the invention in coordination with one another. Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

As used herein, the term “store” can include any business or place of business. The store can be a brick and mortar store or an online store. The store can be any person or entity that sells a product.

As used herein, the term “product” can include any item or service. Thus, the term “product” can refer to physical products, digital goods, services, or anything for which a user can make a payment, including charitable donations. A product can be anything that can be sold. Examples of products include cellular telephones, concerts, meals, hotel rooms, automotive repair, haircuts, digital music, and books. The product can be a single item or a plurality of items. For example, the product can be a tube of toothpaste, a box of laundry detergent, three shirts, and a donut.

As used herein, the term “merchant” can include any seller of products. The term merchant can include a store. The products can be sold from a store or in any other manner. As used herein, the term “mobile device” can include any portable electronic device that can facilitate data communications, such as via a cellular network and/or the Internet. Examples of mobile devices include cellular telephones, smart phones, tablet computers, and laptop computers.

As used herein, the term “network” can include one or more local area networks (LANs) such as business networks, one or more wide area networks (WANs) such as the Internet, one or more cellular telephone networks, or any other type or combination of electronic or optical networks.

As used herein, the term “card” can refer to any card or other device that can be used to make a purchase in place of cash. For example, the card can be a bank card, credit card, debit card, gift card, or other device. The card can be a token, such as a hardware token or a software token. The card can be stored in and/or displayed upon a user device, such as a cellular telephone.

Purchase histories, wish lists, and the like can be used, at least in part, to infer product recommendations and budgets for a user. In this manner, the user can better and more easily determine what product to purchase with discretionary money. Such recommendations and budgets can make shopping substantially easier for the user. Indeed, shopping can be, at least to some degree, automated. Thus, the use of such recommendations can facilitate the purchase of more desirable and useful products for the user and for other. The use of such budgets can help the user to better manage the user's money.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

What is claimed is:

1. A system comprising:
one or more memories storing purchase information;
one or more hardware processors in communication with the one or more memories and operable to:
access the purchase information;
determine, at least in part from the purchase information, a recommendation for purchasing a product;
determine, at least in part from the recommendation, a budget for purchasing the product; and
send to the user a communication including the recommendation and the budget.

2. The system of claim 1, wherein the recommendation is based, at least in part, upon an amount of discretionary money available in at least one account of the user.

3. The system of claim 2, wherein the one or more hardware processors are operable to determine the amount of discretionary money.

4. The system of claim 2, wherein the one or more hardware processors are operable to determine the amount of discretionary money based, at least in part, upon the purchase information.

5. The system of claim 1, wherein the purchase information comprises a purchase history.

6. The system of claim 1, wherein the purchase information comprises a wish list.

7. The system of claim 1, wherein the recommendation is based, at least in part, upon previous purchases of the user.

8. The system of claim 1, wherein the recommendation is based, at least in part, upon previous purchases of an intended gift recipient.

9. The system of claim 1, wherein the one or more hardware processors are operable to receive authorization from the user to purchase the product.

10. The system of claim 1, wherein the one or more hardware processors are operable to receive a modification to the recommendation and budget from the user.

11. The system of claim 1, wherein the one or more hardware processors are operable to automatically purchase the product.

12. The system of claim 1, wherein the one or more hardware processors are operable to provide the recommendation in response to a request from user.

13. The system of claim 1, wherein the one or more hardware processors are operable to provide the recommendation automatically.

14. The system of claim 1, wherein sending to the user the communication including the recommendation and the budget comprises sending the communication to a user device.

15. The system of claim 1, wherein the purchase information comprises purchase information of the user.

16. The system of claim 1, wherein the purchase information comprises purchase information of an intended gift recipient.

17. The system of claim 1, wherein the one or more memories are one or more memories of a server.

18. The system of claim 1, wherein the one or more hardware processors are one or more hardware processors of a server.

19. The system of claim 3, wherein:
a portion of the amount of discretionary money is not included in the budget; and
the portion of the amount of discretionary money not included in the budget is designated for a use that is predefined by the user.

20. The system of claim 3, wherein:
a portion of the amount of discretionary money is not included in the budget; and
the portion of the amount of discretionary money not included in the budget is used to purchase another gift.

21. The system of claim 3, wherein:
a portion of the amount of discretionary money is not included in the budget; and
the a portion of the amount of discretionary money not included in the budget is moved to another account of the user.

22. A method comprising:
storing, in one or more memories, purchase information;
accessing, via one or more hardware processors in communication with the one or more memories, the purchase information;
determining, via the one or more hardware processors and at least in part from the purchase information, a recommendation for purchasing a product;
determining, via the one or more hardware processors and at least in part from the recommendation, a budget for purchasing the product; and
sending to the user a communication including the recommendation and the budget.

23. A computer program product comprising a non-transitory computer readable medium having computer readable and executable code for instructing one or more processors to perform a method, the method comprising:
storing purchase information;
accessing the purchase information;
determining a recommendation for purchasing a product;
determining a budget for purchasing the product; and
sending to the user a communication including the recommendation and the budget.
